(19) United States
(12) Patent Application Publication
(10) Pub. No.: US 2008/0116595 A1
(43) Pub. Date: May 22, 2008

(54) Plastic Optical Fiber Preform and Method for Manufacturing The Same

(75) Inventors: Masataka Sato, Shizuoka (JP); Aya Uchino, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Tokyo (JP)

(21) Appl. No.: 11/662,885

(22) PCT Filed: Sep. 5, 2005
(86) PCT No.: PCT/JP05/16684

§ 371 Date: Mar. 15, 2007

(30) Foreign Application Priority Data
Sep. 22, 2004 (JP) 2004-275500

(51) Int. Cl. G02B 6/028; B29D 11/00

(52) U.S. Cl. 264/1.24; 385/124

(57) ABSTRACT

A core (33) is formed by polymerization of core material that is poured in a hollow part of a tubular inner clad (19) formed inside an outer clad (18). The inner core material comprises a first core monomer having the structural unit of the inner clad (19), a second core monomer different from the first core monomer, and a non-polymerizable refractive index control agent. While the first and second core monomers are copolymerized, the concentration of the refractive index control agent in the core (33) is gradually changed to generate a refractive index profile in the core (33). The second structural unit is the second core monomer can improve heat-resistance of the core (33), and prevent microscopic phase-separation near the interface between the inner clad (19) and the core (33).

### TECHNICAL FIELD

The present invention relates to a plastic optical fiber preform for a plastic optical fiber and a method for manufacturing such plastic optical fiber preform.

### BACKGROUND ART

A plastic material as an optical transmission medium has merits of molding facility, light weight, low manufacture cost, excellent flexibility and high shock-resistance, compared with a glass material. For instance, a plastic optical fiber (POF) as the optical transmission medium is not suitable in transmitting optical signals for a long distance because of large transmission loss compared with a glass optical fiber, but the above mentioned characteristics of the plastic optical fiber makes it possible to increase the diameter of the core to several hundred micrometers or larger. Thereby, it is not required to precisely connect the optical fiber with an optical device for connecting the optical fibers. Thus, the plastic optical fiber has the merits of facility in connection due to a large diameter, facility in fiber terminal process, non-necessity for core alignment with high precision. Moreover, due to the characteristics of the plastic material, the plastic optical fiber has advantages of cost reduction of the connecter, low danger to prick into human body, easy construction, high resistance to vibration and low price. Accordingly, it is planned to utilize the plastic optical fiber not only as household and automobile purposes but as a short-distance, high-capacity cable such as inner wirings for high-speed data processing device and a digital video interface (DVI) link.

The plastic optical fiber (hereinafter referred to as “POF”) is composed of a core part and a clad part. The core part is formed inside the clad part, and has a higher refractive index than the clad part. As the optical fiber having excellent transmittance, there is a graded index type POF in which the refractive index in the core part gradually changes from the center to the interface between the core part and the clad part. The graded index type POF is manufactured by forming an optical fiber base body (preform), and melt-drawing the preform.

In manufacture of the preform, a polymerizable compound for the core part is poured in a clad pipe, and the clad pipe including the polymerizable compound is set in a tubular chamber. The core part is formed by polymerization of the polymerizable compound while the tubular chamber is rotating. During polymerization, the polymerizable compound is polymerized from the clad part side toward the center of the core part. Moreover, the amount of the refractive index control agent is changed in the radial direction of the core part, so the refractive index in the core part gradually changes in the radial direction of the core part. Thereafter, the preform manufactured in this way is subject to a melt-drawing process to manufacture the graded index type POF, as described in International Publication WO 93/08488.

According to the method of manufacture described in the above reference, in the event that the refractive index control agent distributed in the radial direction of the preform is a polymerizable compound, the polymer near the interface between the core part and the clad part tends to have microscopic phase-separated structure. Especially, when the core part is formed by swelling the inner wall of the clad part, the area near the interface has the mixed polymer of the clad part and the core part. As a result, the polymer near the interface exhibits microscopic phase-separated structure that remains in the POF after the melt-drawing process. The signal light is scattered at the interface between the polymers in the area having the microscopic phase-separated structure, so the transmission loss increases.

There are various kinds of the refractive index control agent, and non-polymerizable low-molecular weight compound is preferably used in consideration of facility in forming the core part and realization of the refractive index profile. The low-molecular weight compound as the refractive index control agent, however, decreases heat-resistance property of the core part.

An object of the present invention is to provide a method for manufacturing the plastic optical fiber preform to prevent microscopic phase-separated structure and keep the heat-resistance of the core part including the refractive index control agent.

Another object of the present invention is to provide a plastic optical fiber having excellent optical transmittance and heat-resistance manufactured by the above manufacture method.

### DISCLOSURE OF INVENTION

In order to achieve the above objects, the plastic optical fiber preform comprising a circular tubular first member having an inner wall formed from a first polymer including a first structural unit U1, and a second member formed in the first member and having a higher refractive index than the first member. The second member comprises a copolymer of the first structural unit U1 and a second structural unit U2 different form the first structural unit U1, and the refractive index in the second member gradually increases from the inner wall of the first member toward the center of the second member.

The plastic optical fiber is manufactured by pouring a first polymerizable compound, a second polymerizable compound and a non-polymerizable refractive index control agent in the hollow part of the first member, and by polymerizing the first polymerizable compound and the second polymerizable compound such that the copolymer of the first and second polymerizable compounds is formed from the inner wall of the first member toward the center of the second member.

In a preferable embodiment, the homopolymer of the second structural unit U2 has a higher glass transition temperature than the first polymer. The difference in the refractive index between the homopolymer of the second structural unit U2 and the first polymer is 0 to 0.1, and the difference in the refractive index between the first member and the second member is 0.001 or higher. The first polymer may be a homopolymer. The weight percent of the second structural unit U2 in the second polymer may be 1-20 wt %.

The second member may comprise plural second polymer layers. The weight percent of the second structural unit U2 in a first layer in the second member contacting the first member is 1-20 wt %, and the weight percent of the second structural unit U2 in an nth layer (n: natural number larger than 1) is larger by 1-20 wt % than that in an (n−1)th layer.

According to the present invention, since the second polymer in the preform contains the copolymer of the first and second structural units, it is possible to reduce microscopic phase-separated structure in the manufactured preform, and to improve heat-resistance of the core including the refractive index control agent.

### BRIEF DESCRIPTION OF DRAWINGS

FIG. 1 is a flow chart to manufacture a plastic optical fiber;

FIG. 2 is a sectional view of a preform;

FIG. 3 is a graph to show the refractive index profile in the radial direction of the preform of FIG. 3;

FIG. 4 is a graph of concentration of the refractive index control agent in the radial direction of the preform of FIG. 3;

FIG. 5 is a graph of concentration of the second structural unit in the radial direction of the preform of FIG. 3;

FIG. 6 is a sectional view of the plastic optical fiber;

FIG. 7 is a graph to show the refractive index profile in the radial direction of the plastic optical fiber of FIG. 6;

FIG. 8 is a graph of concentration of the refractive index control agent in the radial direction of the plastic optical fiber of FIG. 6;

FIG. 9 is a graph of concentration of the second structural unit in the radial direction of the plastic optical fiber of FIG. 6;

FIG. 10 is a sectional view of a polymerization chamber in polymerization of an inner clad of the preform;

FIG. 11 is a schematic view of a rotation polymerization apparatus;

FIG. 12 is a sectional view, in essential part, of the rotation polymerization apparatus;

FIG. 13 is a sectional view of the polymerization chamber in polymerization of a core of the preform; and

FIG. 14 is a section view of the preform according to another embodiment.

### BEST MODE FOR CARRYING OUT THE INVENTION

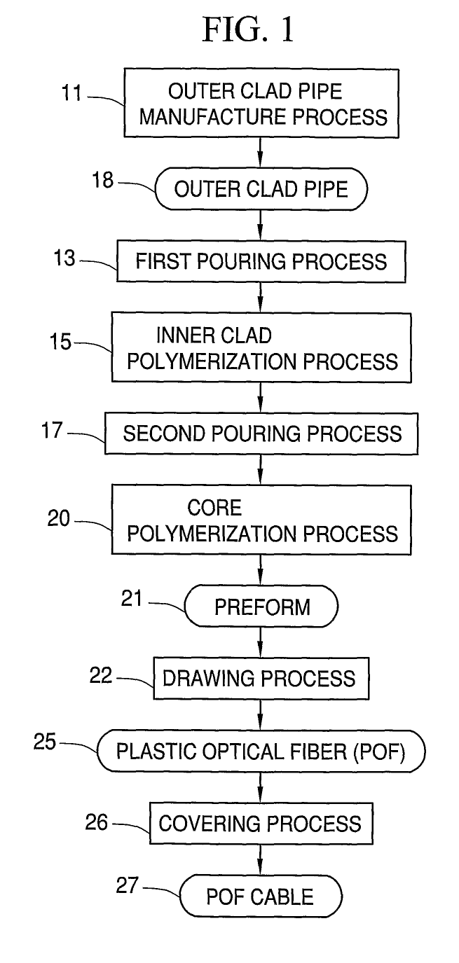

The preferable embodiments of the present invention are hereinafter described with reference to the drawings, but these embodiments do not limit the present invention. FIG. 1 shows a flow chart to manufacture a plastic optical cable. The manufacture processes are described roughly in the following paragraphs, and the details of each process will be described later. In the outer clad pipe manufacture process 11, the tubular outer clad 18 is formed. The outer clad 18 corresponds to the outer shell of the preform 21.

The core 33 and the inner clad 19 are formed in the outer clad 18. The inner clad 19 is formed inside the outer clad 18, and the core 33 is formed inside the inner clad 19. In the first pouring process, the polymerizable compound for the inner clad (inner clad monomer) is poured in the tubular outer clad 18. Then, in the inner clad formation process 15, the inner clad monomer is polymerized to form the tubular inner clad 19 in which a hollow part is generated in the center thereof. In the event of forming the inner clad 19 by interface gel polymerization as the bulk polymerization to carry out polymerization while the polymer absorbing the polymerizable compound is melted and swelled, the polymer formed before the polymerization process is melted as polymerization process proceeds. Thus, when the core 33 is formed by interfacial gel polymerization, the inner clad 19 tends to be integrated with the core 33, so the inner clad 19 becomes hard to be recognized.

The polymerizable compound for the core (core monomer) is poured in the inner clad 19 in the second pouring process 17, and then the core 33 is formed in the core formation process 20. Thereby, the preform 21 is obtained. The polymerizable compounds for the inner clad 19 and the core 33 are referred to as inner clad monomer and the core monomer respectively, but these compounds for the inner clad 19 and the core 33 include monomer, dimer, trimer and other polymerizable compound for forming kinds of polymers described later.

In the drawing process 22, a plastic optical fiber (POF) 25 is manufactured by drawing the preform 21. In the drawing process 22, the cylindrical preform 21 is heated and drawn in the longitudinal direction. It is to be noted that the preform 21 functions as the optical transmission medium. In the coating process 26, the POF 25 is coated with a coating material. Although the POF 25 is normally coated with a first coating layer and then with a second coating layer, more than two coating layer may be formed around the POF 25. The POF 25 after the coating process 26 is called as a plastic optical fiber strand or a plastic optical code. In this embodiment, a plastic optical cable 27 includes a single fiber cable and a multi fiber cable. The single fiber cable has the single optical fiber strand (coated if necessary). The multi fiber cable comprises plural optical fiber strands bunched with tension members that are covered with a coating layer.

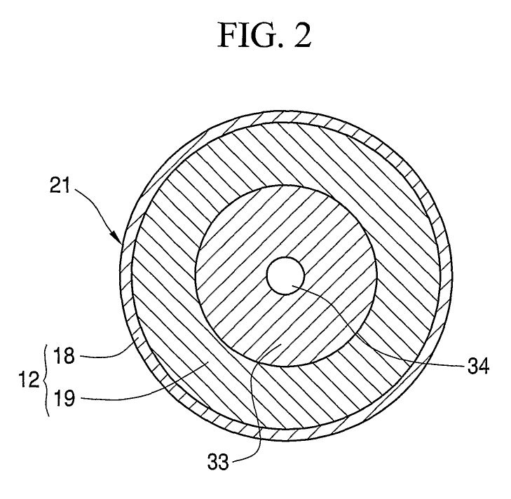

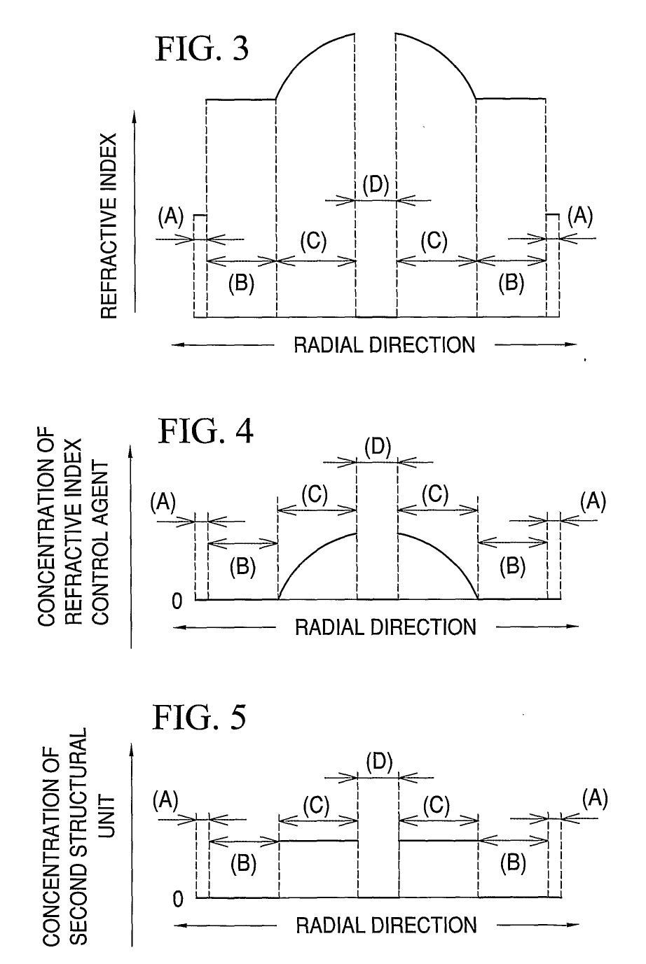

The particulars of the preform 21 are hereinafter described with reference to the drawings. FIG. 2 is the cross section of an example of the preform 21. The graph in FIG. 3 shows the refractive index profile of the preform 21 in the radial direction. The graph in FIG. 4 is the concentration of the refractive index control agent in the radial direction. And the graph in FIG. 5 is the concentration of certain structural unit in the radial direction of the preform 21. It is to be noted that the present invention is not limited to the characteristics shown in these graphs.

Referring to FIG. 2, the preform 21 has the clad 12 and the core 33, and the clad 12 comprises an outer clad 18 and an inner clad 19 formed in the outer clad 18. The outer clad 18 and the inner clad 19 have a tubular shape with uniform thickness in the longitudinal direction. The outer diameter and the inner diameter of the outer clad 18 and the inner clad 19 are also uniform in the longitudinal direction. Although a void 34 is depicted in the center of the preform 21 in FIG. 2, the existence of the void 34, the relationship between the size of the void 34 and the diameter of the preform 21 depend on the manufacture condition of the preform 21.

The refractive index in the clad 12 is different from that in the core 33. In FIG. 3, the horizontal axis indicates the distance from the center of the preform 21, and the vertical axis indicates the refractive index. The refractive index increases as the line in the graph goes upward. In FIG. 4, the horizontal axis indicates the distance from the center of the preform 21, and the vertical axis indicates the concentration of the refractive index control agent. As the line in the graph goes upward, the refractive index control agent increases. The lowest value of the refractive index control agent is zero. In the horizontal axis of FIGS. 3 and 4, the range (A) corresponds to the outer clad 18, the range (B) corresponds to the inner clad 19, the range (C) corresponds to the core 33, and the range (D) corresponds to the void 34. In the range (D), the refractive index and the concentration take no value or zero.

As shown in FIG. 3, the refractive index in the outer clad 18 is smaller than that in the inner clad 19, and the refractive index in the inner clad 19 is substantially the same as the minimum value of the refractive index in the core 33. Preferably, the refractive index in the inner clad 19 is smaller by 0.001 or more than the minimum value of the refractive index in the core 33. The refractive index in the core 33 gradually increases from the outer surface of the core 33 toward the center of the preform 21 (or toward the void 34). In order to provide such refractive index profile in the core 33, the core monomer is added with the refractive index control agent, and the core 33 is formed by the rotational gel polymerization that will be described later.

The graph in FIG. 4 shows that the concentration of the refractive index control agent in the preform 21 in the radial direction increases from the outer clad 18 toward the void 34. Concretely, the refractive index control agent is not included in the outer clad 18 and the inner clad 19, and the concentration in the core 33 gradually increases toward the void 34. Such distribution of the refractive index control agent to provide the refractive index profile in the inner clad 19 and the core 33 is generated by the rotational gel polymerization.

The refractive index distribution coefficient in the preform 21 and the POF 25 is known as the value g in the following equations:

n(r)=n1{1−(r/R)^{g}×Δ}^{1/2}(r≦R) (1)

n(r)=n1(1−Δ)(r>R) (2)

wherein “R” is the outer diameter of the preform 21 or the core 33 of the POF 25, “r” is the distance from the center of the cross section of the preform 21 or the POF 25, “n1” is the maximum value of the refractive index in the radial direction, “n2” is the minimum value of the refractive index, and Δ is the value of (n1−n2)/n1.

The refractive index profile coefficient of the preform 21 and the POF 25 in this embodiment is 0.5 to 4.0, more preferably 1.5 to 3.0, and most preferably 2.0. If the refractive index profile coefficient is larger than 4.0, high speed optical transmission of about 1 G bit per second for 100 m becomes difficult because the signal pulse is largely distorted due to large delay of high-mode component of the signal light. On the other hand, the refractive index profile coefficient of 0.5 or smaller makes distortion of signal pulse worse because the high mode component is transmitted faster than the low mode component, and thus the fast transmission becomes difficult. In this embodiment, the refractive index profile coefficient is controlled by adjusting the amount of the refractive index control agent to be added in forming the core 33, the reaction speed of the core polymerization process, and so forth.

The materials of the clad 12 and the core 33 are explained. The outer clad 18 is formed from a polymer having a low refractive index, and the outer clad 18 in this embodiment is formed from polyvinylidene fluoride (PVDF) by melt-extrusion by use of a commercial type melt-extrusion machine. The outer clad 18 may be formed from polymethyl methacrylate (PMMA) by rotation polymerization, or from other material that will be described later.

The material of the inner clad 19 is selected in consideration of the refractive index and affinity to at least one of the outer clad 18 and the core 33. The inner clad 19 in this embodiment is a homo polymer (first polymer) in which a first structural unit U1 is repeated. The core 33 in this embodiment is a copolymer (second polymer) having the first structural unit U1 and a second structural unit U2. It is to be noted that the structural unit stands for a chemical structural unit, and the minimum of the structural unit is a repetitive unit to form the homo polymer. In other words, the concentration of the second structural unit U2 is zero in the outer clad 18 and the inner clad 19, as shown in FIG. 5. In the core 33, the weight ratio of the second structural unit U2 is 1% to 20% of the first structural unit U1. Thus, the weight ratio of the second structural unit U2 in the second polymer is different by 1% to 20% than that in the first polymer.

In this embodiment, the first polymer of the inner clad 19 is PMMA formed from the monomer that will be described later. The second polymer is the core 33 is the copolymer of MMA and isobornyl methacrylate (IBMA) in which the weight ratio of the PIBMA is 1% to 20% of PMMA. For the purpose of improving transmission property, PMMA in the core 33 may be substituted for deuteriated polymethylmethacrylate (PMMA-d) in which the hydrogen atom is replaced with deuterium atom.

Although the preform 21 in FIG. 2 has a clear border between the inner clad 19 and the core 33, the border is not clearly identified in the actually formed preform 21 because the inner clad 19 and the core 33 are formed from the above polymer by the following formation method.

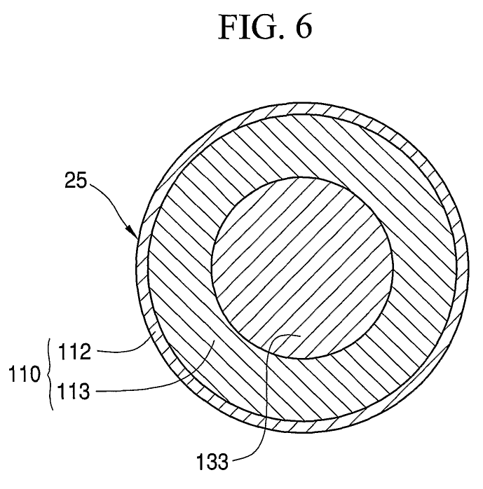

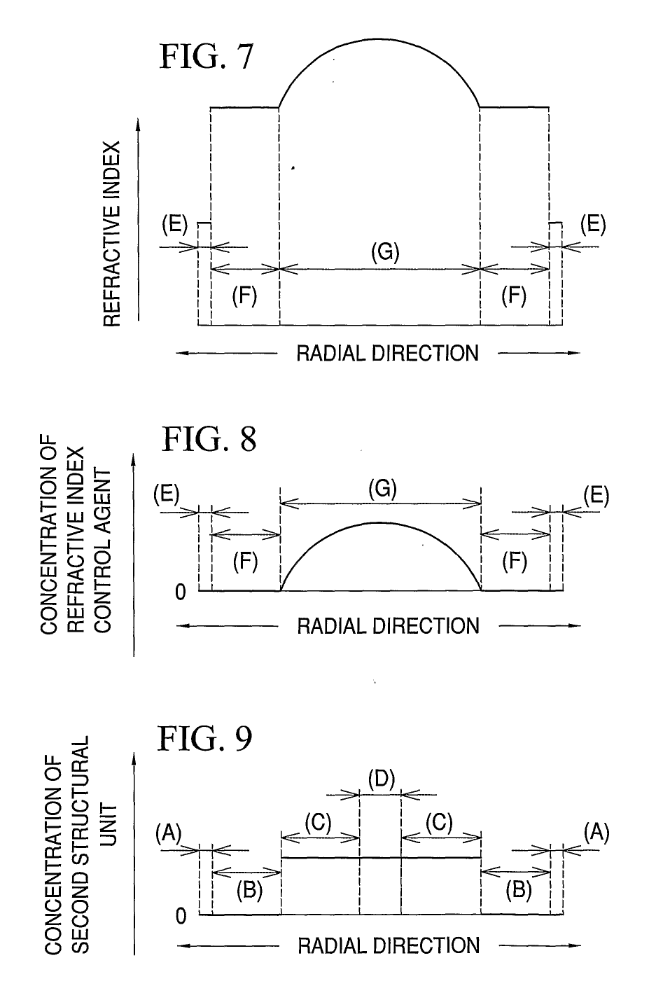

The particulars of the POF 25 (see FIG. 1) obtained by melt-drawing the preform 21 are described with reference to the drawings. The cross section of the POF 25 (see FIG. 1) obtained by melt-drawing the preform 21 is depicted in FIG. 6. The graph in FIG. 7 shows the refractive index profile of the POF 25 in the radial direction. The graph in FIG. 7 is the concentration of the refractive index control agent in the radial direction. And the graph in FIG. 8 is the concentration of certain structural unit in the radial direction of the POF 25. As shown in FIG. 6, the POF 25 comprises a clad 110 and a core 133, and the clad 110 comprises an outer clad 112 and an inner clad 113. The void 34 (see FIG. 2) disappears in the POF 25, because the preform 21 is heated and drawn in the longitudinal direction thereof.

The horizontal axis and the vertical axis in FIGS. 7 to 9 are the same as those in FIGS. 3 to 5, respectively. In the horizontal axis in FIGS. 7 to 9, the range (E) corresponds to the outer clad 112, the range (F) corresponds to the inner clad 113, and the range (G) corresponds to the core 133. Referring to FIG. 7, the refractive index in the outer clad 112 is lower than that in the inner clad 113, and the refractive index in the core 133 is higher than that in the inner clad 113. The refractive index in the core 133 gradually increases as the distance from the center of the POF 25 decreases. The refractive index profile coefficient of the POF 25 is substantially the same as that of the preform 21. The refractive index profile of the preform 21 is already described.

As shown in FIG. 8, the concentration of the refractive index control agent in the core 133 increases toward the center of the POF 25. The outer clad 112 and the inner clad 113 do not contain the refractive index control agent. Such distribution in the concentration of the refractive index control agent of the POF 25 depends on that of the preform 21, and causes the refractive index profile of the preform 21.

As shown in FIG. 9, the concentration of the second structural unit U2 in the POF 25 is zero in the outer clad 112 and the inner clad 113, and the core 133 includes the second structural unit U2. The concentration of the POF 25 is basically the same as that of the preform 21, so the main component of the inner clad 113 is the first structural unit U1. The main component of the core 133 is the second structural unit U2, and the weight ratio of the second structural unit U2 to the first structural unit U1 is 1% to 20% in the core 133. Thus, the weight ratio of the second structural unit U2 in the second polymer is different by 1% to 20% than that in the first polymer.

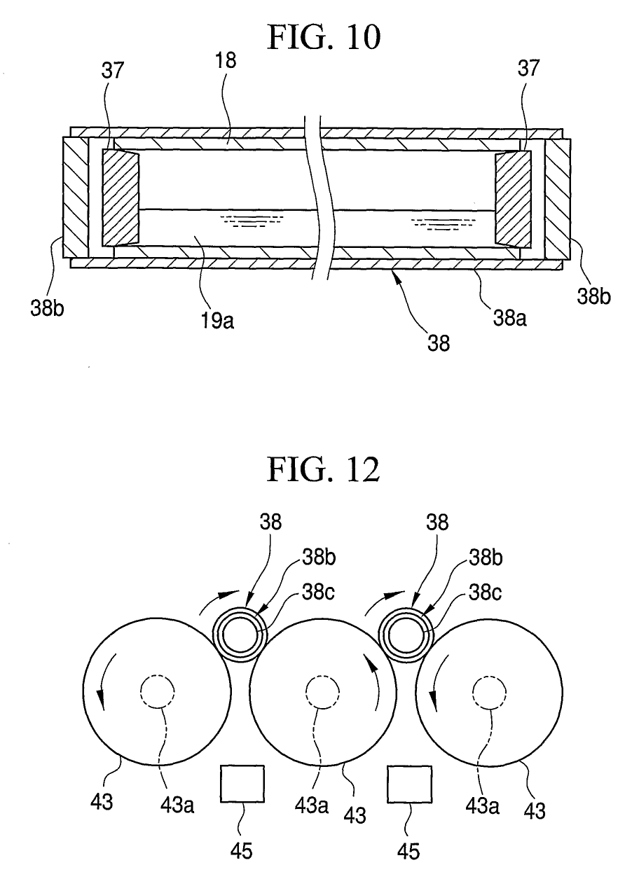

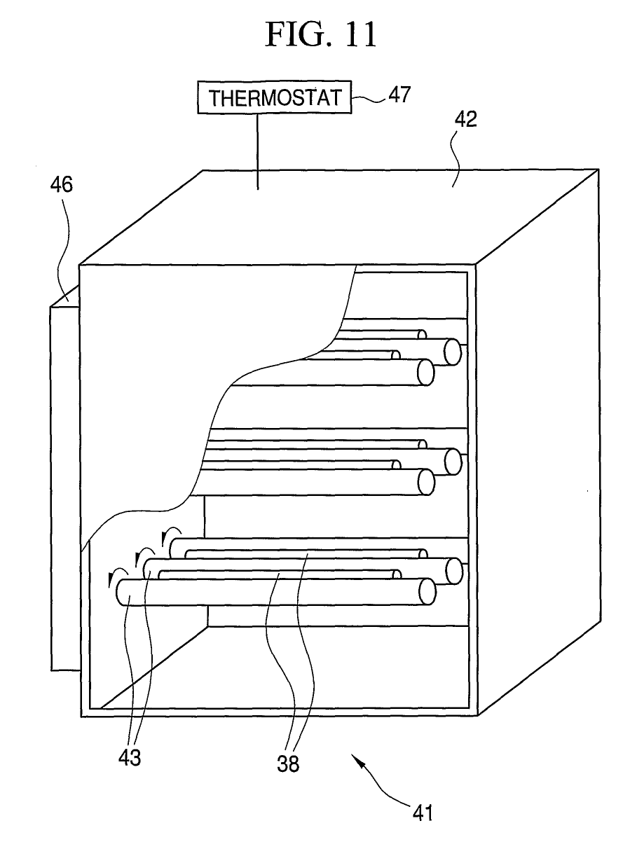

The method of manufacture of the preform 21 is described with reference to the drawings. FIG. 10 shows the cross section of a polymerization chamber. In FIG. 11, the rotation polymerization apparatus is schematically illustrated. And In FIG. 12, the polymerization chamber is illustrated. The polymerization apparatus shown in FIGS. 10 to 12 is an embodiment of the present invention, and does not limit the scope of the present invention.

In forming the inner clad 19 inside the outer clad 18, one end of the outer clad 18 is sealed with a plug 37 formed from a material that is not dissolved by the polymerizable compound for the core 33. Example of the material of the plug 37 is polytetrafluoroethylene (PTFE). The plug 37 does not contain the compound that flows out a plasticizer. After sealing one end of the outer clad 18, an outer core material 32a including the outer core monomer is poured in the hollow area of the outer clad 18. The other end of the outer clad 18 is sealed with the plug 37, and then the inner clad 19 (see FIG. 2) is formed by polymerization of the inner clad monomer while the outer clad 18 is rotated. In polymerization of the inner clad monomer, the outer clad 18 is kept in the polymerization chamber 38 that comprises a cylindrical chamber body 38a and a pair of lids 38b for sealing both ends of the chamber body 38a. The chamber body 38a and the lids 38b are made of SUS. As shown in FIG. 10, the inner diameter of the polymerization chamber 38 is slightly larger than the outer diameter of the outer clad 18, and the rotation of the outer clad 18 is synchronized with the rotation of the polymerization chamber 38. In order to ensure to rotate the outer clad 18 together with the polymerization chamber 38, a support member may be provided in the inner wall of the polymerization chamber 38.

In the inner clad polymerization process 15 (see FIG. 1), the above described polymerization chamber 38 is set in a rotation polymerization apparatus 41. Referring to FIG. 11, the rotation polymerization apparatus 41 comprises plural rotation members 43, a drive section 46 and a thermostat 47. The drive section 46 and the thermostat 47 are provided outside of the housing 42. The thermostat 47 measures the temperature in the housing 42, and controls the temperature in the housing based on the measured temperature.

The cylindrical rotation members 43 are arranged in parallel such that the polymerization chamber 38 is supported by adjacent two rotation members 43. One end of the rotation member 43 is rotatably supported by the inner wall of the housing 42, and independently driven by the drive section 46. The drive section 46 has a controller (not illustrated) for controlling the operation of the drive section 46. In polymerization, the polymerization chamber 38 is held in the space between the surfaces of the adjacent rotation members 43, and rotated in accordance with the rotation of the rotation members 43 around the rotational axis 43a, as shown in FIG. 12. The method to rotate the polymerization chamber 38 is not limited to the surface drive type described in this embodiment.

Referring to FIGS. 10 and 12, the polymerization chamber 38 is kept from moving upward during the rotation because of a magnet 38c provided in the lid 38b and a magnet 45 provided below the adjacent rotation members 43. In addition, upper rotation members may be provided above the polymerization chamber 38, and the upper rotation members may be rotated together with the rotation members 43 to prevent the polymerization chamber 38 from moving upward. It is also possible to provide holding means above the polymerization chamber 38 to apply certain weight to the polymerization chamber 38, but the method to hold the polymerization chamber 38 does not limit the scope of the present invention.

Next, the inner clad formation process is described. The inner clad material 19a including the inner clad monomer will be explained later. The inner clad 19 between the core 33 and the outer clad 18 affects the polymerization of the core monomer. The inner clad material 19a is preferably used after removing polymerization prohibition agent, moisture, impurities and so forth, by filtering and distillation. After the inner clad monomer and the polymerization initiator are mixed, the mixture is preferably subject to ultrasonic wave process to remove dissolved gas and volatile component. The outer clad 18 and the inner clad material 19a may be decompressed by use of a known decompression apparatus just after or before the first pouring process 13, if necessary.

Thereafter, the polymerization chamber 38 containing the outer clad 18 is loaded in the rotation polymerization apparatus 41 such that the longitudinal axis of the polymerization chamber 38 is kept substantially horizontally. The inner clad 19 is formed by polymerization of the inner clad material 19a while the polymerization chamber 38 is rotated. In this way, the inner clad 19 is formed by rotation polymerization in which the inner clad material 19a is polymerized while the tubular outer clad 18 is rotated around the cylinder axis. Before the rotation polymerization, the inner clad material 19a may be subject to preliminary polymerization in which the outer clad 19 is kept substantially vertically. In the preliminary polymerization, a rotation mechanism may be provided to rotate the outer clad 19 around the cylinder axis, if necessary. The rotation polymerization process can form the inner clad layer on the whole inner surface of the outer clad 18 because the longitudinal axis of the outer clad 18 is kept horizontally. In forming the inner clad 19, it is preferable that the longitudinal axis of the outer clad 18 is kept horizontally in order to form the inner clad layer on the whole inner surface of the outer clad 18, the longitudinal axis of the outer clad 18 may be kept roughly horizontal. The permissible angle of the vertical axis of the outer clad 18 is about 5° to the ground.

The outer core material 19a comprises the outer core monomer, the polymerization initiator (reaction initiator). Examples of the outer core monomer are radical polymerizable compound and anion polymerizable compound. The polymerization initiator may be substituted for a catalyst according to the type of the inner clad monomer. The inner clad material may be contained the chain transfer agent (molecular amount control agent).

The inner clad monomer is a polymerizable compound having the first structural unit U1, and in this embodiment, the inner clad monomer is polymethyl methacrylate (PMMA) or deuteriated methylmethacrylate (MMA-d) that is reacted in response to radical polymerization and anion polymerization. The inner clad material may be the radical polymerizable compound and anion polymerizable compound other than PMMA and MMA-d. Examples of the preferable inner clad monomer will be described later.

The amount of the polymerization initiator and the catalyst for formation of the inner clad is 0.001 mol % to 5.0 mol % of the inner clad monomer, and more preferably 0.01 mol % to 0.1 mol %.

In this embodiment, the polymerization initiator is 2,4-dimethylvaleronitrile (V-65), but the polymerization initiator is not limited to this. The polymerization initiator and the catalyst may be selected in accordance to the kind of the inner clad monomer to be used. As the polymerization initiator, the commercial type for low/medium temperature is preferable. The polymerization initiator for low/medium temperature has the ten-hour half-life temperature of 40 to 90° C. The suitable reaction temperature with the polymerization initiator for high temperature is about 90 to 130° C., so the polymerization initiator for low/medium temperature enables reaction at a low temperature of 50 to 80° C. Moreover, it is possible to shorten the formation period of the inner clad 19 by controlling the conversion rate at a certain period and controlling the polymerization speed. Therefore, such polymerization initiator can prevent deterioration of the outer clad 18 due to low reaction temperature and short reaction period. Examples of the polymerization initiator and the catalyst for formation of the inner clad 19 will be listed in the description of the polymerization initiator and the catalyst for formation of the core 33.

The amount of the chain transfer agent is 0.05 mol % to 0.8 mol % of the inner clad monomer, and preferably 0.05 mol % to 0.4 mol %.

The chain transfer agent to be added is selected in accordance with the kind of the inner clad monomer. Examples of the chain transfer agent will be listed in the description of the chain transfer agent in the core polymerization process.

The method of manufacture of the outer clad 18 and the inner clad 19 is not limited to the above embodiment, but any known method may be used to manufacture the outer clad 18 and the inner clad 19. For example, the outer clad 18 and the inner clad 19 may be formed by simultaneous extrusion. Alternatively, the inner clad monomer is poured in a hollow part of a glass tube having a certain inner diameter, and the glass tube is removed to obtain the inner clad 19. The tubular outer clad 18 is fixed to the outer wall of the inner clad 19, or the outer clad 18 may be formed on the inner clad 19.

The outer clad 18 having the inner clad 19 is taken out of the rotation polymerization apparatus 35, and then the outer clad 18 is subject to heating process by use of a heating machine such as the thermostat at a predetermined temperature.

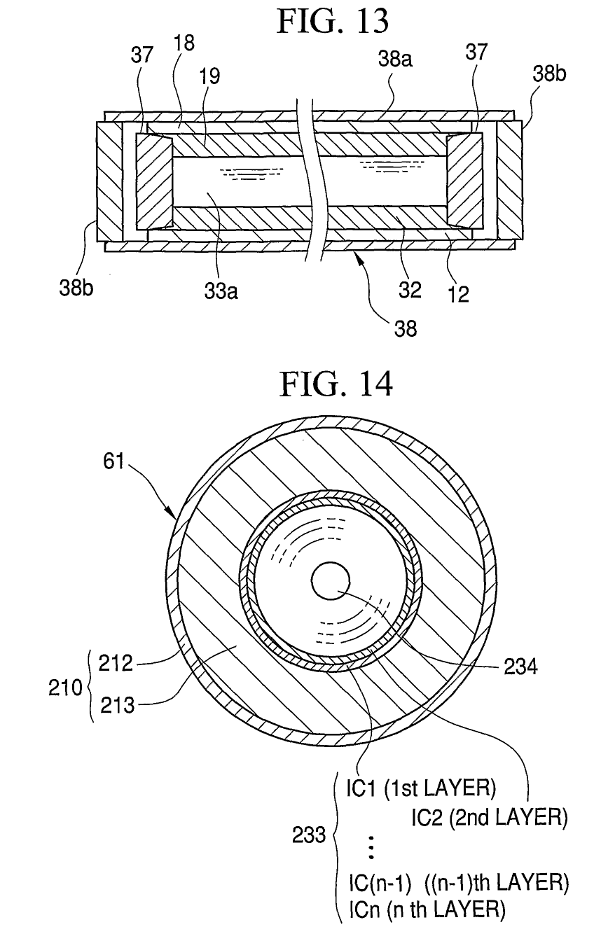

The core is formed by polymerization. Referring to FIG. 13 showing the polymerization chamber 38 used in formation of the inner clad 19, the core material 33a containing the inner core monomer is poured in the hollow part of the inner clad 19. Then, both edges of the clad 12 are sealed with the plugs 37, and the clad 12 is set in the polymerization chamber 38 such that the longitudinal axis of the clad 12 is kept horizontally. While the clad 12 is rotated around the cylinder axis thereof, the core monomer is polymerized to form the core 33.

The clad 12 and the inner core monomer may be subject to decompression process by use of a known decompression apparatus just before or/and after pouring the core material 33a, if necessary.

Polymerization of the core monomer is carried out by use of the rotation polymerization apparatus 41 (see FIG. 11) used for formation of the inner clad 19. During polymerization of the core monomer, the polymerization chamber 38 containing the clad 12 is rotated such that the cylindrical axis of the clad 12 is kept horizontally.

When the core monomer starts polymerization, the core monomer swells the inner wall of the inner clad 19 to generate a gelled swelled layer in an initial stage of polymerization. Such swelled layer accelerates polymerization of the core monomer (gel effect). In this embodiment, polymerizable compound poured into a tubular body is reacted to the revolving tubular body to form a swelled layer, so the polymerizable compound is polymerized. Such process for polymerization is referred to as the rotational gel polymerization process. Polymerization of the core monomer proceeds from the inner wall of the inner clad 19 toward the center of the cross section of the clad 12. In polymerization, the compound having smaller molecular volume tends to move to the swelled layer, so the dopant having relatively large molecular volume tends to move from the swelled layer side to the center of the clad. As a result, the concentration of the dopant having high refractive index increases in the center of the core, and the preform 21 has the refractive index profile in which the refractive index increases from the inner clad side toward the center of the core 33.

Since the preform 21 is formed by generating the swelled layer, the preform 21 does not have a clear border between the inner clad 19 and the core 33. The cross section in FIG. 2 shows the border inner clad 19 and the core 33, the clearness of the border changes in accordance with the affinity of the inner clad 19 to the core 33, the manufacture condition like generation of the swelled layer, and so forth. When the polymers for the inner clad 19 and the core 33 have common component as described in this embodiment, the affinity of the inner clad 19 to the core 33 is high. Thus, the border between the inner clad 19 and the core 33 is invisible, and density fluctuation in the area near the border becomes small. Therefore, the area near the border has excellent transparency, so the POF 25 obtained by drawing the preform 21 has excellent transmittance.

In order to evaluate the conversion rate of the polymerizable compounds for the core 33 and the inner clad 19, an experiment is carried out in advance to obtain the relationship between the visual evaluation and the quantitative evaluation of the residual monomer by use of a gas chromatography. Then, the conversion rate of the polymerizable compound is obtained by visual evaluation based on the above relationship. Any well-known method to measure the conversion rate may be applicable.

It is preferable to control the reaction speed. For example, the reaction speed is preferably adjusted such that the conversion rate for an hour is 5-90%, more preferably 10-85%, and most preferably 20-80%. The reaction speed is controlled by adjusting the kind of the polymerization initiator, the polymerization temperature, and so forth.

The reaction speed is preferably adjusted such that the conversion rate of the polymerizable compound becomes 99-100% in a period of 1-3 times of the half-life of the polymerization initiator at a predetermined polymerization temperature. It is also preferable that the conversion rate becomes 99-100% by the heating process after two hours from initiation of polymerization.

In this embodiment, polymerization of the core monomer and the reaction of the inner clad monomer to the core monomer are considered to be bulk-polymerization. In addition, polymerization of the inner clad monomer and the reaction of the outer clad to the inner clad are bulk-polymerization. The bulk-polymerization can reduce the amount of bubbles in the core 33.

The reaction temperature in the rotational gel polymerization is preferably equal to or smaller than the boiling point of the polymerizable compound to be used. In the event of MMA or MMA-d as the polymerizable compound, the reaction temperature is preferably 30-100° C., and more preferably 40-80° C. The reaction period is preferably 0.5-20 hours, and more preferably 1.5-3.0 hours. The rotational speed of the polymerization chamber 38 is preferably 500-4000 rpm, and more preferably 1500-3500 rpm.

The core material will be described. The core material contains a first core monomer, a second core monomer, the polymerization initiator (reaction initiator), and the refractive index control agent (dopant). As the core monomer, the radical polymerization compound and the anion polymerizable compound may be used. The catalyst may be substituted for the polymerization initiator. The chain transfer agent (molecular weight control agent) may be added to the core material, if necessary.

The first core monomer has the first structural unit U1, and the second core monomer has the second structural unit U2 different from the first structural unit U1. The homopolymer of the second structural unit U2 has a higher glass transition temperature than the first polymer as the homopolymer of the first structural unit U1. The polymer of the first core monomer can have the same structure as the inner clad 19. The core 33 is a second polymer as the copolymer of the first core monomer and the second core monomer. In this embodiment, the first core monomer is MMA or MMA-d that is the same as the inner clad monomer. The second core monomer is isobornyl methacrylate (IBMA).

The first core monomer has high affinity to the inner clad 19, so the first core monomer is easily dissolved in the inner clad 19, and dissolution of the inner clad 19 to the core monomer improves. Thus, polymerization of the core monomer by forming the swelled layer makes it possible not to exhibit microscopic phase separation between the second polymer and the first polymer as the inner clad 19. Thereby, the signal light through the POF formed from the preform according to this embodiment is less scattered, compared with the optical fiber formed from a conventional preform. Moreover, copolymer of the first core monomer and the second core monomer has the advantage of high heat-resistance of the POF even though the dopant is added to the preform 21.

The refractive index of the homopolymer of the second core monomer is different by 0 to 0.1 from the refractive index of the inner clad 19. The difference in the refractive index between the inner clad 19 and the core 33 is 0.001 or larger. Thereby, the POF 25 having such refractive index relationship between the inner clad 19 and the core 33 exhibits excellent property as the optical transmission passage. Selecting the second core monomer having such refractive index makes it possible to reduce light scattering in the swelled layer.

The weight ratio of the second core monomer to the total of the core monomer is preferably 1-20%. In that case, the weight ratio of the second structural unit U2 in the core is higher by 1-20 wt % than the inner clad 19 that does not contain the second structural unit U2. Including the second core monomer of 1-20 wt % of the core monomer makes it possible to improve heat-resistance of the core 33, to reduce microscopic phase-separation, and to decrease the difference in the refractive index between the core 33 and the inner clad 19.

The amount of the polymerization initiator or the catalyst for formation of the core is 0.001 to 5.0 weight percent of the core monomer, and more preferably 0.010 to 0.10 weight percent.

In this embodiment, the polymerization initiator is 2,4-dimethylvaleronitrile (V-65), but the polymerization initiator is not limited to this. The polymerization initiator and the catalyst may be selected in accordance to the kind of the core monomer to be used. As the polymerization initiator, the commercial type for low/medium temperature is preferable. The suitable reaction temperature with the polymerization initiator for high temperature is about 80 to 110° C., so the polymerization initiator for low/medium temperature enables reaction at a low temperature of 40 to 80° C. Moreover, it is possible to shorten the formation period of the core 33 by controlling the conversion rate at a certain period and controlling the polymerization speed. Therefore, such polymerization initiator can prevent deterioration of the outer clad due to low reaction temperature and short reaction period. Examples of the polymerization initiator and the catalyst for formation of the core will be listed in the description of the polymerization initiator and the catalyst for formation of the inner clad.

For the purpose of shorten the reaction period, the radical polymerization initiator having the half-life period of 2 hours or less at 40° C. to 90° C. is effective.

The amount of the chain transfer agent is 0.05 mol % to 0.8 mol % of the core monomer, and preferably 0.15 mol % to 0.4 mol %.

The chain transfer agent to be added is selected in accordance with the kind of the core monomer. Examples of the chain transfer agent will be listed in the description of the chain transfer agent in the inner clad polymerization process.

The amount of the dopant is preferably 0.01 wt % to 25 wt % of the core monomer, more preferably 1 wt % to 20 wt %. Thereby, the refractive index profile coefficient of the core 33 becomes within the preferable range described above.

In the above embodiment, the dopant for changing the refractive index in the radial direction of the core is diphenyl sulfide as a non-polymerizable low molecular weight compound having high refractive index and large molecular volume. Alternatively, the refractive index profile in the core 33 may be generated by use of more than one kind of the core monomer. In that case, the core monomer has first and second compounds that are copolymerizable. The second compound has a larger refractive index than the first compound. The first and second compounds are polymerized to form the refractive index profile by use of the difference in the reaction between the first compounds and the reaction between the first and second compounds.

In this embodiment, after polymerization of the core under the above described condition, the preform 21 is subject to heating process for polymerization. After polymerization is completed, the preform 21 is cooled at a predetermined cooling speed.

In this way, it is possible to manufacture the preform as a cylindrical optical transmission medium having the plastic clad 12 and the plastic core 33. The preform 21 is then subject to the drawing process 22.

In the drawing process 22, the method described in JP-A No. 07-234322 may be used, for example. By the drawing process 22, the POF having the diameter of 200 μm to 1000 μm is manufactured.

The clad and core material for the preform and the POF is organic material with high optical transparency. The material for the clad is a polymer having a smaller refractive index than the core and the clad such that the signal light is completely reflected at the interface between the core and the clad. Moreover, the clad material is preferably a polymer having no optical anisotropy. The core and the clad are preferably the polymer with excellent fitness to each other, excellent toughness, moisture resistance and heat-resistance. The preferable materials for the core, the inner clad and the outer clad are explained below.

The outer clad material is preferably the polymer having fluorine for the purpose of ensuring enough difference in the refractive index between the outer clad 18 and the inner clad 19. Examples of the outer clad material are polyvinylidene fluoride (PVDF) and (meta)acrylic ester resin fluoride. Examples of the inner clad material are methyl methacrylate (MMA), deuteriated methylmethacrylate (MMA-d), trifluoroethylmethacrylate (3FMA), and benzyl methacrylate (BzMA), as described in International Patent Publication WO 93/08488. The core material is preferably the copolymer of a chemical structural unit for the inner clad and the polymerizable compound the homopolymer of which has a higher glass transition temperature than the inner clad. Examples of the core material are isopropyl methacrylate (IPMA), t-butylmethacrylate (tBMA), isobornyl methacrylate (IBMA), norbonyl methacrylate (NBMA), and tricyclodecanyl methacrylate (TCDMA). In the event of MMA as the main component of the core monomer, isobornyl methacrylate (IBMA) is preferably used as the sub-component, for example.

Examples of the polymerization initiators that generate radicals are peroxide compounds, such as benzoil peroxide (BPO); tert-butylperoxy-2-ethylhexanate (PBO); di-tert-butylperoxide (PBD); tert-butylperoxyisopropylcarbonate (PBI); n-butyl-4,4-bis(tert-butylperoxy)valarate (PHV), and the like. Other examples of the polymerization initiators are azo compounds, such as 2,2′-azobisisobutylonitril; 2,2′-azobis(2-methylbutylonitril); 1,1′-azobis(cyclohexane-1-carbonitryl); 2,2′-azobis(2-methylpropane); 2,2′-azobis(2-methylbutane) 2,2′-azobis(2-methylpentane); 2,2′-azobis(2,3-dimethylbutane); 2,2′-azobis(2-methylhexane); 2,2′-azobis(2,4-dimethylpentane); 2,2′-azobis (2,3,3-trimethylbutane); 2,2′-azobis(2,4,4-trimethylpentane); 3,3′-azobis(3-methylpentane); 3,3′-azobis(3-methylhexane); 3,3′-azobis(3,4-dimethypentane); 3,3′-azobis(3-ethylpentane); dimethyl-2,2′-azobis(2-methylpropionate); diethyl-2,2′-azobis(2-methylpropionate); di-tert-butyl-2,2′-azobis(2-methylpropionate), and the like. Note that the polymerization initiators are not limited to the above substances. More than one kind of the polymerization initiators may be combined.

For the purpose of keeping mechanical and thermal properties of the whole polymer, it is preferable to control the degree of polymerization by use of the chain transfer agent. The kind and the amount of the chain transfer agent are selected in accordance with the kinds of the polymerizable monomer. The chain transfer coefficient of the chain transfer agent to the respective monomer is described, for example, in “Polymer Handbook, 3^{rd} edition”, (edited by J. BRANDRUP & E. H. IMMERGUT, issued from JOHN WILEY & SON). In addition, the chain transfer coefficient may be calculated through the experiments in the method described in “Experiment Method of Polymers” (edited by Takayuki Ohtsu and Masayoshi Kinoshita, issued from Kagakudojin, 1972).

Preferable examples of the chain transfer agent are alkylmercaptans [for instance, n-butylmercaptan; n-pentylmercaptan; n-octylmercaptan; n-laurylmercaptan; tert-dodecylmercaptan, and the like], and thiophenols [for example, thiophenol; m-bromothiophenol; p-bromothiophenol; m-toluenethiol; p-toluenethiol, and the like]. It is especially preferable to use n-octylmercaptan, n-laurylmercaptan, and tert-dodecylmercaptan in the alkylmercaptans. Further, the hydrogen atom in C—H bond may be substituted by the fluorine atom (F) or a deuterium atom (D) in the chain transfer agent. Note that the chain transfer agents are not limited to the above substances. More than one kind of the chain transfer agents may be combined.

The GI type POF having excellent transmission property enables wide band optical transmission, compared with other type of the POF. Thus, the GI type POF is preferably applied to the high performance communication purpose. The refractive index profile may be introduced in the core by combining plural polymerization units in the core polymer, by copolymerizing plural polymerization units, or by adding the dopant.

The dopant is the compound having different refractive index from the inner clad 19. The difference in the refractive indices between the dopant and the inner clad 19 is preferably 0.005 or larger. The dopant has the feature to increase the refractive index of the polymer, compared to one that does not include the dopant. In comparison of the polymers produced from the monomers as described in Japanese Patent Publication No. 3332922 and Japanese Patent Laid-Open Publication No. 5-173026, the dopant has the feature that the difference in solution parameter is 7 (cal/cm³)^{1/2} or smaller, and the difference in the refractive index is 0.001 or larger. Any materials having such features may be used as the dopant if such material can stably exist with the polymers, and the material is stable under the polymerizing condition (such as temperature and pressure conditions) of the polymerizable monomers as described above.

The sp value (solubility parameter) of the dopant is preferably 11 or smaller, and logP of the dopant is preferably 4.0 or smaller. Although there are various methods to measure the sp value as the index of the solubility, this embodiment applies the Fedors method (see “Polymer Engineering and Science”, volume 14, page 147-). According to this method, sp value is 7-11, and more preferably 8-11. According to this method, sp value of PMMA is 9.9. The value of logP is the index whether the compound is hydrophilic or hydrophobic. In this embodiment, the value of logP is measured by use of MaclogP version 4.0 (Macintosh version of ClogP, manufactured by BioByte Corp.). The value of logP is preferably 1-4, more preferably 2-3. According to this method, the value of logP of dimer model of PMMA is 2.63. For the purpose of keeping the transmission loss in a hot and humid atmosphere, the difference in the value of logP between the core polymer and the dopant is preferably as small as possible.

This embodiment shows the method to form refractive index profile in the core by mixing the dopant with the polymerizable compound for the core, by controlling the direction of polymerization according to the interface gel polymerizing method, and by providing gradation in density of the refractive index control agent as the dopant during the process to form the core. Alternatively, the refractive index control agent may be diffused after formation of the preform. Hereinafter, the core having the refractive index profile will be referred to as “graded index core”. Such graded index core is used for the graded index type plastic optical member having wide range of transmission band.

The dopant is the compound not to be polymerized with the core monomer and the core. In other words, the dopant may be oligomer (dimer or trimer) as long as the dopant is not polymerized with the core monomer. Even if the monomer of the compound is polymerizable with the core monomer or the core, oligomer of such compound may be used as the dopant if such oligomer is not polymerizable with the core monomer or the core.

Examples of the dopant are benzyl benzoate (BEN); diphenyl sulfide (DPS); triphenyl phosphate (TPP); benzyl n-butyl phthalate (BBP); diphenyl phthalate (DPP); diphenyl (DP); diphenylmethane (DPM); tricresyl phosphate (TCP); diphenylsoufoxide (DPSO). Among them, BEN, DPS, TPP, DPSO are preferable. The refractive index in the POF can be controlled by adjusting the density and distribution of the dopant in the core.

Other additives may be contained in the core and the clad so far as the transmittance properties do not decrease. For example, the additives may be used for increasing resistance of climate and durability. Further, induced emissive functional compounds may be added for amplifying the optical signal. When such compounds are added to the monomers, weak signal light is amplified by excitation light so that the transmission distance increases. Therefore, the optical member with such additive may be used as an optical fiber amplifier. These additives may be contained in the core and/or the clad by polymerizing the additives with the monomers.

The POF is normally coated with at least one protective layer, for the purpose of improving flexural and weather resistance, preventing decrease in property by moisture absorption, improving tensile strength, providing resistance to stamping, providing resistance to flame, protecting damage by chemical agents, noise prevention from external light, increasing the value by coloring, and the like.

The present invention is also applicable to the core having plural layers. Referring to FIG. 14 showing the cross section of a preform 61 according to another embodiment, the preform 61 comprises a clad 210 and a core 233. The clad 210 comprises an outer clad 212 and an inner clad 213. The core 233 has plural layers in which a first layer (IC1), a second layer (IC2) . . . a (n−1)th layer (IC(n−1)) and a nth layer (ICn) are arranged from the inner clad side to the center of the preform 61 in this order listed. Note that “n” is a natural number of 2 or larger, and the preform 21 according to the above described embodiment corresponds to the preform 61 under the condition of n=2.

The inner clad 213 of the preform 61 is formed inside the outer clad 212 by the same method as the preform 21 according to the above embodiment. The core 233 is formed inside the inner clad 213 by formation of the first layer (IC1), the second layer (IC2) . . . the (n−1)th layer (IC(n−1)) and the nth layer (ICn) in this order listed. Initially, the core monomer for the first layer is poured in the hollow part of the inner clad 213, and the core monomer is polymerized by application of energy while the polymerization chamber 38 containing the inner clad 213 is rotated in the rotation polymerization apparatus 41 (see FIG. 11). When the conversion rate of the core monomer for the first layer becomes about 80%, the core monomer for the second layer is poured in the hollow part of the first layer. Then, the core monomer for the second layer is subject to polymerization in the same method as formation of the first layer. When the conversion rate of the core monomer for the second layer becomes about 80%, the core monomer for the third layer is poured in the hollow part of the second layer.

The core monomer for the next layer is preferably poured based on the conversion rate of the previous layer. The conversion rate to pour the core monomer for the next layer is preferably about 80%. Thereby, it is possible mix the polymers of adjacent layers and thus to prevent microscopic phase-separation in the area near the border of adjacent layers. In order to provide refractive index profile in the core, the concentration of the non-polymerizable refractive index control agent added in the core monomer for respective layer increases from the first layer to the nth layer. In this embodiment, the amount of the refractive index control agent and the polymerization speed are controlled such that the refractive index profile coefficient g in the core 233 is 1.5 to 3.0.

The POFs obtained by drawing the preform are subject to the first coating process to manufacture the optical fiber strand, and one fiber strand or several fiber strands are subject to the second coating process to manufacture the optical cable. In the event of the optical cable having single optical fiber, it is possible not to carry out the second coating process and to utilize the optical cable with the outermost layer coated by the first coating process. As for the type of coating, there are a contact type coating in which the coating layer contacts the whole surface of the POF, and a loose type coating in which a gap is provided between the coating layer and the POF. When the coating layer of the loose type is peeled for attaching a connector, it is possible that the moisture enters the gap between the POF and the coating layer and extends in the longitudinal direction of the optical fiber cable. Thus, the contact type coating is preferable.

The loose type coating, however, has the advantage in relaxing the damage caused by stress and heat to the optical fiber cable due to the gap between the coating layer and the POF. Since the damage to the POF decreases, the loose type coating is preferably applied to some purposes. It is possible to shield moisture from entering from the lateral edge of the optical fiber cable by filling gelled or powdered material in the gap. If the gelled or powdered material as the filler is provided with the function of improving heat-resistance and mechanical strength, the coating layer with excellent properties can be realized. The loose type coating layer can be formed by adjusting the position of the extrusion nipple of the cross head die, and by controlling the pressure in a decompression device. The thickness of the gap layer between the POF and the coating layer can be controlled by adjusting the thickness of the nipple and pressure to the gap layer.

The coating layer formed on the POF in the first and second coating processes may contain the additives such as flame retardant, ultraviolet absorber, antioxidant and lubricant as long as the optical properties of the POF are not affected.

The flame retardants are resin with halogen like bromine, an additive and a material with phosphorus. Metal hydroxide is preferably used as the flame retardant for the purpose of reducing toxic gas emission. The metal hydroxide contains water of crystallization that is not removed during the manufacture of the POF, so the metal hydroxide as the flame retardant is preferably added to the outermost coating layer of the optical cable, not to the coating layer that is directly contacted to the POF.

The POF may be coated with plural coat layers with multiple functions. Examples of such coat layers are a flame retardant layer described above, a barrier layer to prevent moisture absorption, moisture absorbent (moisture absorption tape or gel, for instance) between the protective layers or in the protective layer, a flexible material layer and a styrene forming layer as shock absorbers to relax stress in bending the POF, a reinforced layer to increase rigidity. Examples of the structural material (coating material) of the plastic optical fiber other than the resin are thermoplastic resin containing tensile strength fiber with high elasticity and/or a metal wire with high rigidity. These materials are preferable in terms of improving the mechanical strength of the manufactured optical cable.

Examples of the tensile strength fibers are an aramid fiber, a polyester fiber, a polyamid fiber. Examples of the metal wires are stainless wire, a zinc alloy wire, a copper wire. The tensile strength fibers are not limited to those listed above. It is also possible to provide other materials such as a metal pipe for protection, a support wire to hold the optical fiber cable. A mechanism to increase working efficiency in wiring the optical fiber cable is also applicable.

In accordance with the way of use, the POF is selectively used as a cable assembly in which the optical fiber strands are circularly arranged, a tape core wire in which the optical fiber strand are linearly aligned, a cable assembly in which the tape core wires are bundled by using a band or LAP sheath, or the like.

Compared with the conventional optical fiber cable, the optical fiber cable containing the POF according to the present invention has large permissible error in the core position, the optical fiber cables may be connected directly. But it is preferable to ensure to fix the end of the optical cable by use of an optical connector. The optical connectors widely available on the market are PN type, SMA type, SMI type and the like.

A system to transmit optical signals through the POF, the optical fiber wire and the optical fiber cable as the optical member comprises optical signal processing devices including optical components, such as a light emitting element, a light receiving element, an optical switch, an optical isolator, an optical integrated circuit, an optical transmitter and receiver module, and the like. Such system may be combined with other POFs. Any know techniques can be applied to the present invention. The techniques are described in, for example, “‘Basic and Practice of Plastic Optical Fiber’ (issued from NTS Inc.)”, “‘Optical members can be Loaded on Printed Wiring Assembly, at Last’ in Nikkei Electronics, vol. Dec. 3, 2001”, pp. 110-127”, and so on. By combining the optical member according to with the techniques in these publications, the optical member is applicable to short-distance optical transmission system that is suitable for high-speed and large capacity data communication and for control under no influence of electromagnetic wave. Concretely, the optical member is applicable to wiring in apparatuses (such as computers and several digital apparatuses), wiring in trains and vessels, optical linking between an optical terminal and a digital device and between digital devices, indoor optical LAN in houses, collective housings, factories, offices, hospitals, schools, and outdoor optical LAN.

Further, other techniques to be combined with the optical transmission system are disclosed, for example, in “‘High-Uniformity Star Coupler Using Diffused Light Transmission’ in IEICE TRANS. ELECTRON., VOL. E84-C, No. 3, MARCH 2001, pp. 339-344”, “‘Interconnection in Technique of Optical Sheet Bath’ in Journal of Japan Institute of Electronics Packaging., Vol. 3, No. 6, 2000, pp. 476-480”. Moreover, there are am optical bus (disclosed in Japanese Patent Laid-Open Publications No. 10-123350, No. 2002-90571, No. 2001-290055 and the like); an optical branching/coupling device (disclosed in Japanese Patent Laid-Open Publications No. 2001-74971, No. 2000-329962, No. 2001-74966, No. 2001-74968, No. 2001-318263, No. 2001-311840 and the like); an optical star coupler (disclosed in Japanese Patent Laid-Open Publications No. 2000-241655); an optical signal transmission device and an optical data bus system (disclosed in Japanese Patent Laid-Open Publications No. 2002-62457, No. 2002-101044, No. 2001-305395 and the like); a processing device of optical signal (disclosed in Japanese Patent Laid-Open Publications No. 2000-23011 and the like); a cross connect system for optical signals (disclosed in Japanese Patent Laid-Open Publications No. 2001-86537 and the like); a light transmitting system (disclosed in Japanese Patent Laid-Open Publications No. 2002-26815 and the like); multi-function system (disclosed in Japanese Patent Laid-Open Publications No. 2001-339554, No. 2001-339555 and the like); and various kinds of optical waveguides, optical branching, optical couplers, optical multiplexers, optical demultiplexers and the like. When the optical system having the optical member according to the present invention is combined with these techniques, it is possible to construct an advanced optical transmission system to send/receive multiplexed optical signals. The optical member according to the present invention is also applicable to other purposes, such as for lighting, energy transmission, illumination, and sensors.

The present invention will be described in detail with reference to Experiment (1) as the embodiment of the present invention and Experiments (2)-(4) as the comparisons. The materials, contents, operations and the like will be changed so far as the changes are within the spirit of the present invention. Thus, the scope of the present invention is not limited to the Experiments described below.

[Experiment (1)]

In Experiment (1), the outer clad 18 is a hollow tube formed from PVDF by melt-extrusion. The outer clad 18 has the inner diameter of 19 mm and the length of 60 cm. The inner clad material is poured in the hollow part of the outer clad 18. The inner clad material is the mixture of MMA of 114 g as the radical polymerizable compound, 2,4-dimethylvaleronitrile (Product name; V-65, manufactured by Wako Pure Chemical Industries, Ltd.) as the polymerization initiator, n-laurylmercaptan as the chain transfer agent. The moisture of MMA is reduced to 100 ppm or smaller by distillation. The inner clad material is poured in the outer clad 18 after controlling the temperature of the inner clad material. The moisture of 2,4-dimethylvaleronitrile is reduced to 200 ppm. The amount of 2,4-dimethylvaleronitrile and n-laurylmercaptan are 0.04 mol % and 0.2 mol % of MMA, respectively. The outer clad 18 containing the inner clad material is loaded in the polymerization chamber body 38a of the rotation polymerization apparatus 41 such that the longitudinal axis of the outer clad 18 is kept horizontally. The inner clad material is subject to thermal polymerization for 2 hours at 70° C. while the polymerization chamber 38 is rotated at 2000 rpm. A non-grounded thermocouple is provided at a position 1-2 cm from the polymerization chamber 38, and the measured temperature is considered as the polymerization temperature. The peak temperature during the polymerization is measured by use of the thermocouple. In Experiment 1, the measured peak temperature is 67° C. at the time of about 80 minutes after starting polymerization. After polymerization of the inner clad monomer, the inner clad 19 of PMMA (refractive index n=1.49) is formed inside the outer clad 18.

The core material is poured in the hollow part of the inner clad 19 at a room temperature and an atmospheric pressure. The core material is the mixture of MMA as the first core monomer, IBMA as the second core monomer, 2,4-dimethylvaleronnitrile (V-65) as the polymerization initiator, n-laurylmercaptan as the chain transfer agent, and diphenylsulfide (DPS) as the non-polymerizable dopant. The moisture of MMA and IBMA is removed to 100 ppm or smaller by distillation, and the weight ratio between MMA and IBMA is 90:10. The refractive index of IBMA homopolymer is 1.500. The added amount of 2,4-dimethylvaleronnitrile, n-laurylmercaptan and DPS to MMA are respectively 0.04 mol %, 0.20 mol % and 10 wt %.

The outer clad 18 containing the core material is set again in the chamber body 38a of rotation polymerization apparatus 41 such that the longitudinal direction of the outer clad 18 is kept horizontally. The core material is subject to thermal polymerization for 2 hours at 70° C. while the polymerization chamber 38 is rotated at 2000 rpm. The measured peak temperature is 67° C. at the time of about 80 minutes after starting polymerization. The conversion rate of the core material after 2 hours of polymerization is 90%. Thereafter, the core monomer is heated for 24 hours at 120° C. while the polymerization chamber 38 is rotated at 500 rpm. The conversion rate of the core material is 99% or higher. Then, the polymerization chamber 38 is rotated for natural cooling. Thereby, the preform 21 having the inner clad 19 of PMMA and the core 33 of MMA/IBMA copolymer is manufactured. The preform 21 is subject to the drawing process to manufacture the POF 25.

The preform 21 has a hollow part in the center of the cross section in the core 33. The refractive index profile coefficient of the core 33 is 3.2. Thermal analysis of the sample of the core 33 by use of a Differential Scanning Calorimetry (DSC) shows that the glass transition temperature Tg of the core 33 is higher by 10° C. than PMMA.

The manufactured POF 25 has the outer diameter of 500 μm and the length of 500 m. The transmission loss of the POF 25 at the wavelength of 650 nm is 170 dB/km. The POF is coated with low density polyethylene (JAC06M, manufactured by JPO) such that the POF with the coating layer has the diameter of 1.9 mm. The coated POF having the length of 13 m is separated as the sample, and the middle portion of the POF sample having the length of 10 m is set in a small environmental test machine SH-240, and the portions of 2 m and 1 m from both edges of the POF outside of the test machine are respectively connected to a white light source (AQ4303B, manufactured by Ando Electric Co., Ltd.) and an optical power meter (ML910B, manufactured by Anritsu Corporation) by FC connectors (MA9013A, manufactured by Anritsu Corporation). An interference filter (03FIR006, manufactured by MELLES GRIOT KK) is inserted in the white light source. The temperature and the relative humidity of a constant temperature/humidity cabinet is 70° C. and 95%, respectively. The measured attenuation of the light intensity after 500 hours is 1 dB.

[Experiment (2)]

In Experiment (2), the polymerizable compound of the core is only PMMA, and IBMA as the second core monomer is not used. Other conditions are the same as those in Experiment (1).

The glass transition temperature Tg of the sample of the core is lower than the glass transition temperature of PMMA. The transmission loss of the POF, obtained by drawing the preform, at the wavelength of 650 nm is 170 dB/km. The transmission loss of the POF after moisture absorption for 100 hours is 30 dB.

[Experiment (3)]

In Experiment (3), the weight ratio between MMA and IBMA as the core monomer is 995:5. Other conditions are the same as those in Experiment (1).

The glass transition temperature Tg of the sample of the core is substantially the same as the glass transition temperature of PMMA. The transmission loss of the POF, obtained by drawing the preform, at the wavelength of 650 nm is 170 dB/km. The transmission loss of the POF after moisture absorption for 100 hours is 20 dB.

[Experiment (4)]

In Experiment (4), the weight ratio between MMA and IBMA as the core monomer is 75:25. Other conditions are the same as those in Experiment (1).

The glass transition temperature Tg of the sample of the core is higher by 10° C. than the glass transition temperature of PMMA. The glass transition temperature of the sample is 100° C. in the center of the core. The transmission loss of the POF, obtained by drawing the preform, at the wavelength of 650 nm is 200 dB/km. The transmission loss of the POF after moisture absorption is the same as the transmission loss before moisture absorption.

[Experiment (5)]

In Experiment (5), the second core monomer is bromo-substituted phenylmethacrylate. The refractive index of homopolymer of bromo-substituted phenylmethacrylate is 1.599. Other conditions are the same as those in Experiment (1).

The glass transition temperature Tg of the sample of the core is higher by 160° C. than the glass transition temperature of PMMA. The core ob the preform becomes clouded. The transmission loss of the POF, obtained by drawing the preform, at the wavelength of 650 nm is 1500 dB/km. The transmission loss of the POF after moisture absorption is the same as the transmission loss before moisture absorption.

According to these Experiments (1)-(5), by controlling the refractive index and the amount of the polymer compound to increase the glass transition temperature Tg in forming the core by polymerization of the structural unit of the outer core polymer and the such compound, it is possible to manufacture the preform in which microscopic phase-separation in the polymer of the preform is controlled and the heat-resistance does not become worse even with the refractive index control agent. Thus, the POF obtained by drawing such preform has excellent optical transmittance and practical heat-resistance.

### INDUSTRIAL APPLICABILITY

The present invention relates to a plastic optical fiber preform for a plastic optical fiber and a method for manufacturing such plastic optical fiber preform.

1. A manufacturing method of a plastic optical fiber preform having a circular tubular first member and a second member formed in a hollow part of the first member, the refractive index of the second member being higher than the refractive index of the first member, the method comprising the steps of:
(a) pouring a first polymerizable compound, a second polymerizable compound and a non-polymerizable refractive index control agent in the hollow part of the first member, the first member having an inner wall formed from a first polymer including a first structural unit U1, the first polymerizable compound having the first structural unit U1, and the second polymerizable compound having a second structural unit U2 different from the first structural unit U1; and
(b) polymerizing the first polymerizable compound and the second polymerizable compound such that the copolymer of the first and second polymerizable compounds is formed from the inner wall of the first member toward the center of the second member.

2. The manufacturing method according to claim 1, wherein the homopolymer of the second structural unit U2 has a higher glass transition temperature than the first polymer.

3. The manufacturing method according to claim 1, wherein the difference in the refractive index between the homopolymer of the second structural unit U2 and the first polymer is 0 to 0.1, and the difference in the refractive index between the first member and the second member is 0.001 or higher.

4. The manufacturing method according to claim 1, wherein the first polymer is a homopolymer.

5. The manufacturing method according to claim 1, wherein the weight percent of the second structural unit U2 in the second polymer is 1-20 wt %.

6. The manufacturing method according to claim 1, further comprising the step of:
(c) repeating the steps (a) and (b) to from the second member having plural second polymer layers, the weight percent of the second structural unit U2 in a first layer in the second member contacting the first member being 1-20 wt %, and the weight percent of the second structural unit U2 in an nth layer (n: natural number larger than 1) being larger by 1-20 wt % than that in an (n−1)th layer.

7. A plastic optical fiber preform comprising:
a circular tubular first member having an inner wall formed from a first polymer including a first structural unit U1; and
a second member formed in the first member and having a higher refractive index than the first member, the second member comprising a copolymer of the first structural unit U1 and a second structural unit U2 different form the first structural unit U1, the refractive index in the second member gradually increasing from the inner wall of the first member toward the center of the second member.

8. The preform according to claim 7, wherein the homopolymer of the second structural unit U2 has a higher glass transition temperature than the first polymer.

9. The preform according to claim 7, wherein the difference in the refractive index between the homopolymer of the second structural unit U2 and the first polymer is 0 to 0.1, and the difference in the refractive index between the first member and the second member is 0.001 or higher.

10. The preform according to claim 7, wherein the first polymer is a homopolymer.

11. The preform according to claim 7, wherein the weight percent of the second structural unit U2 in the second polymer is 1-20 wt %.

12. The preform according to claim 7, wherein the second member comprises plural second polymer layers, the weight percent of the second structural unit U2 in a first layer in the second member contacting the first member is 1-20 wt %, and the weight percent of the second structural unit U2 in an nth layer (n: natural number larger than 1) is larger by 1-20 wt % than that in an (n−1)th layer.
